(19) United States
(12) Patent Application Publication
(10) Pub. No.: US 2014/0270284 A1
(43) Pub. Date: Sep. 18, 2014

(54) CHARACTERISTIC-BASED COMMUNICATIONS

(71) Applicant: Michael Edward Smith Luna, San Jose, CA (US)

(72) Inventor: Michael Edward Smith Luna, San Jose, CA (US)

(73) Assignee: AliphCom, San Francisco, CA (US)

(21) Appl. No.: 13/802,689

(22) Filed: Mar. 13, 2013

(51) Int. Cl. H04S 7/00

(52) U.S. Cl. CPC H04S 7/30
USPC 381/303

(57) ABSTRACT

Embodiments relate generally to electrical and electronic hardware, computer software, wired and wireless network communications, and portable and wearable media devices. Media devices may include a plurality of RF transceivers and an audio system. The RF transceivers and/or audio system may be used to wirelessly communicate between media devices and allow configuration and other data to be wirelessly transmitted from one media device to another media device. Each media device introduced into an eco-system of other media devices is configured to wirelessly communicate with other the devices and to change its role based on media content and data in each devices configuration file that specify user preferences under different circumstances.

### FIELD

Embodiments of the invention relate generally to electrical and electronic hardware, computer software, wired and wireless network communications, wearable, hand held, and portable computing devices for facilitating communication of information. More specifically, disclosed are an ecosystem of wirelessly interconnected media devices that may re-configure themselves based on content to be handled by the media devices and the number of media devices present.

### BACKGROUND

Conventional paradigms for media devices that wirelessly connect with and communicate with each other and/or a user device (e.g., a tablet or smartphone) typically require the user to configure each media device added to the users system of media devices. For example, Bluetooth® (BT) devices require the user to place the media device in BT pairing mode and the user device in BT discovery mode. When the user device detects the BT radio of the media device, the two devices may “pair” with each other. Sometimes, a code must be entered before pairing may occur. After the devices are paired they may wirelessly communicate with each other and depending on the BT protocols, exchange data and control. Typically, when the user adds another BT device, the pairing between the user device and the prior BT device must be broken and the user must pair his/her device with the newly added BT device. For media devices that use other forms of wireless communications, such as WiFi, the process of adding and configuring devices may be more complicated. The user usually has to configure each new media device with information about the wireless network the device will communicate with, such as wireless network name, password, etc. Each wireless device added to the users system may be aware of the wireless network and other entities that are connected with the network; however, many of those devices may not be configured to work well with one another without effort on part of the user to make inter-operability possible. Furthermore, as devices are added to a user's system the roles each device servers in the system may also need to change. Further, in some instances, the role a device servers in a system may need to change based on the content the device is to act on, such as audio, video, phone calls, etc. However, if these wirelessly enabled devices are not designed to work well with one another, then as devices are added to or removed from the system, the user is left with the task of configuring the devices to serve new roles.

Ideally, each media device may sense its surrounding environment and other media devices, and based on content, act to re-configure itself to serve a different role for the user until the circumstances change and the media device reverts back to its prior role or switches to yet another new role.

Thus, what is needed are devices, methods, and software that allow a media device to sense its environment, content to be processed, and user preferences to re-task the role it servers for the user on a dynamic basis.

### BRIEF DESCRIPTION OF THE DRAWINGS

Various embodiments or examples (“examples”) of the invention are disclosed in the following detailed description and the accompanying drawings. The drawings are not necessarily to scale:

FIG. 1 depicts a block diagram of a media device according to an embodiment of the present application;

FIG. 2A depicts one example of a first pairing and configuration scenario for a user device and a media device according to an embodiment of the present application;

FIG. 2B depicts example scenarios for another media device being configured using a configuration from a previously configured media device according to an embodiment of the present application;

FIG. 3 depicts one example of a flow diagram of a process for installing an application on a user device and configuring a first media device using the application according to an embodiment of the present application;

FIGS. 4A and 4B depict example flow diagrams for processes for configuring an un-configured media device according to embodiments of the present application;

FIGS. 5A through 5D depict block diagrams of media devices that configure themselves based on characteristics that may be derived from a variety of inputs, data, configurations, or other information available to the media device according to an embodiment of the present application;

FIGS. 6A through 6E depict block diagrams of an ecosystem of media devices that re-configure themselves to perform different roles according to an embodiment of the present application; and

FIGS. 7A and 7B depict block diagrams of media devices in an ecosystem that use sensor inputs to re-configure roles a media device serves according to an embodiment of the present application.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

FIG. 1 depicts a block diagram of one embodiment of a media device 100 having systems including but not limited to a controller 101, a data storage (DS) system 103, a input/output (I/O) system 105, a radio frequency (RF) system 107, an audio/video (A/V) system 109, a power system 111, and a proximity sensing (PROX) system 113. A bus 110 enables electrical communication between the controller 101, DS system 103, I/O system 105, RF system 107, AV system 109, power system 111, and PROX system 113. Power bus 112 supplies electrical power from power system 111 to the controller 101, DS system 103, I/O system 105, RF system 107, AV system 109, and PROX system 113.

Power system 111 may include a power source internal to the media device 100 such as a battery (e.g., AAA or AA batteries) or a rechargeable battery (e.g., such as a lithium ion or nickel metal hydride type battery, etc.) denoted as BAT 135. Power system 111 may be electrically coupled with a port 114 for connecting an external power source (not shown) such as a power supply that connects with an external AC or DC power source. Examples include but are not limited to a wall wart type of power supply that converts AC power to DC power or AC power to AC power at a different voltage level. In other examples, port 114 may be a connector (e.g., an IEC connector) for a power cord that plugs into an AC outlet or other type of connector, such as a universal serial bus (USB) connector. Power system 111 provides DC power for the various systems of media device 100. Power system 111 may convert AC or DC power into a form usable by the various systems of media device 100. Power system 111 may provide the same or different voltages to the various systems of media device 100. In applications where a rechargeable battery is used for BAT 135, the external power source may be used to power the power system 111, recharge BAT 135, or both. Further, power system 111 on its own or under control or controller 101 may be configured for power management to reduce power consumption of media device 100, by for example, reducing or disconnecting power from one or more of the systems in media device 100 when those systems are not in use or are placed in a standby or idle mode. Power system 111 may also be configured to monitor power usage of the various systems in media device 100 and to report that usage to other systems in media device 100 and/or to other devices (e.g., including other media devices 100) using one or more of the I/O system 105, RF system 107, and AV system 109, for example. Operation and control of the various functions of power system 111 may be externally controlled by other devices (e.g., including other media devices 100).

Controller 101 controls operation of media device 100 and may include a non-transitory computer readable medium, such as executable program code to enable control and operation of the various systems of media device 100. DS 103 may be used to store executable code used by controller 101 in one or more data storage mediums such as ROM, RAM, SRAM, RAM, SSD, Rash, etc., for example. Controller 101 may include but is not limited to one or more of a microprocessor (μP), a microcontroller (μP), a digital signal processor (DSP), a baseband processor, an application specific integrated circuit (ASIC), just to name a few. Processors used for controller 101 may include a single core or multiple cores (e.g., dual core, quad core, etc.). Port 116 may be used to electrically couple controller 101 to an external device (not shown).

DS system 103 may include but is not limited to non-volatile memory (e.g., Flash memory), SRAM, DRAM, ROM, SSD, just to name a few. In that the media device 100 in some applications is designed to be compact, portable, or to have a small size footprint, memory in DS 103 will typically be solid state memory (e.g., no moving or rotating components); however, in some application a hard disk drive (HDD) or hybrid HDD may be used for all or some of the memory in DS 103. In some examples, DS 103 may be electrically coupled with a port 128 for connecting an external memory source (e.g., USB Flash drive, SD, SDHC, SDXC, microSD, Memory Stick, CF, SSD, etc.). Port 128 may be a USB or mini USB port for a Flash drive or a card slot for a Flash memory card. In some examples as will be explained in greater detail below, DS 103 includes data storage for configuration data, denoted as CFG 125, used by controller 101 to control operation of media device 100 and its various systems. DS 103 may include memory designate for use by other systems in media device 100 (e.g., MAC addresses for WiFi 130, network passwords, data for settings and parameters for A/V 109, and other data for operation and/or control of media device 100, etc.). DS 103 may also store data used as an operating system (OS) for controller 101. If controller 101 includes a DSP, then DS 103 may store data, algorithms, program code, an OS, etc. for use by the DSP, for example. In some examples, one or more systems in media device 100 may include their own data storage systems.

I/O system 106 may be used to control input and output operations between the various systems of media device 100 via bus 110 and between systems external to media device 100 via port 118. Port 118 may be a connector (e.g., USB, HDMI, Ethernet, fiber optic, Toslink, Firewire, IEEE 1394, or other) or a hard wired (e.g., captive) connection that facilitates coupling I/O system 105 with external systems. In some examples port 118 may include one or more switches, buttons, or the like, used to control functions of the media device 100 such as a power switch, a standby power mode switch, a button for wireless pairing, an audio muting button, an audio volume control, an audio mute button, a button for connecting/disconnecting from a WiFi network, an infrared (IR) transceiver, just to name a few. I/O system 105 may also control indicator lights, audible signals, or the like (not shown) that give status information about the media device 100, such as a light to indicate the media device 100 is powered up, a light to indicate the media device 100 is in wireless communication (e.g., WiFi, Bluetooth®, WiMAX, cellular, etc.), a light to indicate the media device 100 is Bluetooth® paired, in Bluetooth® pairing mode, Bluetooth® communication is enabled, a light to indicate the audio and/or microphone is muted, just to name a few. Audible signals may be generated by the I/O system 105 or via the AV system 107 to indicate status, etc, of the media device 100. Audible signals may be used to announce Bluetooth® status, powering up or down the media device 100, muting the audio or microphone, an incoming phone call, a new message such as a text, email, or SMS, just to name a few. In some examples, I/O system 105 may use optical technology to wirelessly communicate with other media devices 100 or other devices. Examples include but are not limited to infrared (IR) transmitters, receivers, transceivers, an IR LED, and an IR detector, just to name a few. I/O system 105 may include an optical transceiver OPT 185 that includes an optical transmitter 185t (e.g., an IR LED) and an optical receiver 185r (e.g., a photo diode). OPT 185 may include the circuitry necessary to drive the optical transmitter 185t with encoded signals and to receive and decode signals received by the optical receiver 185r. Bus 110 may be used to communicate signals to and from OPT 185. OPT 185 may be used to transmit and receive IR commands consistent with those used by infrared remote controls used to control AV equipment, televisions, computers, and other types of systems and consumer electronics devices. The IR commands may be used to control and configure the media device 100, or the media device 100 may use the IR commands to configure/re-configure and control other media devices or other user devices, for example.

RF system 107 includes at least one RF antenna 124 that is electrically coupled with a plurality of radios (e.g., RF transceivers) including but not limited to a Bluetooth® (BT) transceiver 120, a WiFi transceiver 130 (e.g., for wireless communications over a wireless and/or WiMAX network), and a proprietary Ad Hoc (AH) transceiver 140 pre-configured (e.g., at the factory) to wirelessly communicate with a proprietary Ad Hoc wireless network (AH-WiFi) (not shown). AH 140 and AH-WiFi are configured to allow wireless communications between similarly configured media devices (e.g., an ecosystem comprised of a plurality of similarly configured media devices) as will be explained in greater detail below. RF system 107 may include more or fewer radios than depicted in FIG. 1 and the number and type of radios will be application dependent. Furthermore, radios in RE system 107 need not be transceivers, RF system 107 may include radios that transmit only or receive only, for example. Optionally, RF system 107 may include a radio 150 configured for RF communications using a proprietary format, frequency band, or other existent now or to be implemented in the future. Radio 150 may be used for cellular communications (e.g., 3G, 4G, or other), for example. Antenna 124 may be configured to be a de-tunable antenna such that it may be de-tuned 129 over a wide range of RF frequencies including but not limited to licensed bands, unlicensed bands, WiFi, WiMAX, cellular bands, Bluetooth®, from about 2.0 GHz to about 6.0 GHz range, and broadband, just to name a few. As will be discussed below, PROX system 113 may use the de-tuning 129 capabilities of antenna 124 to sense proximity of the user, other people, the relative locations of other media devices 100, just to name a few. Radio 150 (e.g., a transceiver) or other transceiver in RF 107, may be used in conjunction with the de-tuning capabilities of antenna 124 to sense proximity, to detect and or spatially locate other RF sources such as those from other media devices 100, devices of a user, just to name a few. RF system 107 may include a port 123 configured to connect the RF system 107 with an external component or system, such as an external RF antenna, for example. The transceivers depicted in FIG. 1 are non-limiting examples of the type of transceivers that may be included in RF system 107. RF system 107 may include a first transceiver configured to wirelessly communicate using a first protocol, a second transceiver configured to wirelessly communicate using a second protocol, a third transceiver configured to wirelessly communicate using a third protocol, and so on. One of the transceivers in RF system 107 may be configured for short range RF communications, such as within a range from about 1 meter to about 15 meters, or less, for example. Another one of the transceivers in RF system 107 may be configured for long range RF communications, such any range up to about 50 meters or more, for example. Short range RF may include Bluetooth®; whereas, long range RF may include WiFi, WiMAX, cellular, and Ad Hoc wireless, for example.

AV system 109 includes at least one audio transducer, such as a loud speaker 160, a microphone 170, or both. AV system 109 further includes circuitry such as amplifiers, preamplifiers, or the like as necessary to drive or process signals to/from the audio transducers. Optionally, AV system 109 may include a display (DISP) 180, video device (VID) 190 (e.g., an image captured device or a web CAM, etc.), or both. DISP 180 may be a display and/or touch screen (e.g., a LCD, OLED, or flat panel display) for displaying video media, information relating to operation of media device 100, content available to or operated on by the media device 100, playlists for media, date and/or time of day, alpha-numeric text and characters, caller ID, file/directory information, a GUI, just to name a few. A port 122 may be used to electrically couple AV system 109 with an external device and/or external signals. Port 122 may be a USB, HDMI, Firewire/IEEE-1394, 3.5 mm audio jack, or other. For example, port 122 may be a 3.5 mm audio jack for connecting an external speaker, headphones, earphones, etc. for listening to audio content being processed by media device 100. As another example, port 122 may be a 3.5 mm audio jack for connecting an external microphone or the audio output from an external device. In some examples, SPK 160 may include but is not limited to one or more active or passive audio transducers such as woofers, concentric drivers, tweeters, super tweeters, midrange drivers, sub-woofers, passive radiators, just to name a few. MIC 170 may include one or more microphones and the one or more microphones may have any polar pattern suitable for the intended application including but not limited to omni-directional, directional, bi-directional, uni-directional, bi-polar, uni-polar, any variety of cardioid pattern, and shotgun, for example. MIC 170 may be configured for mono, stereo, or other. MIC 170 may be configured to be responsive (e.g., generate an electrical signal in response to sound) to any frequency range including but not limited to ultrasonic, infrasonic, from about 20 Hz to about 20 kHz, and any range within or outside of human hearing. In some applications, the audio transducer of AV system 109 may serve dual roles as both a speaker and a microphone.

Circuitry in AV system 109 may include but is not limited to a digital-to-analog converter (DAC) and algorithms for decoding and playback of media files such as MP3, FLAG, AIFF, ALAC, WAV, MPEG, QuickTime, AVI, compressed media files, uncompressed media files, and lossless media files, just to name a few, for example. A DAC may be used by AV system 109 to decode wireless data from a user device or from any of the radios in RE system 107. AV system 109 may also include an analog-to-digital converter (ADC) for converting analog signals, from MIC 170 for example, into digital signals for processing by one or more system in media device 100.

Media device 100 may be used for a variety of applications including but not limited to wirelessly communicating with other wireless devices, other media devices 100, wireless networks, and the like for playback of media (e.g., streaming content), such as audio, for example. The actual source for the media need not be located on a user's device (e.g., smart phone, MP3 player, iPod, iPhone, iPad, Android, laptop, PC, etc.). For example, media files to be played back on media device 100 may be located on the Internet, a web site, or in the cloud, and media device 100 may access (e.g., over a WiFi network via WiFi 130) the files, process data in the files, and initiate playback of the media files. Media device 100 may access or store in its memory a playlist or favorites list and playback content listed in those lists. In some applications, media device 100 will store content (e.g., files) to be played back on the media device 100 or on another media device 100.

Media device 100 may include a housing, a chassis, an enclosure or the like, denoted in FIG. 1 as 199. The actual shape, configuration, dimensions, materials, features, design, ornamentation, aesthetics, and the like of housing 199 will be application dependent and a matter of design choice. Therefore, housing 199 need not have the rectangular form depicted in FIG. 1 or the shape, configuration etc., depicted in the Drawings of the present application. Nothing precludes housing 199 from comprising one or more structural elements, that is, the housing 199 may be comprised of several housings that form media device 100. Housing 199 may be configured to be worn, mounted, or otherwise connected to or carried by a human being. For example, housing 199 may be configured as a wristband, an earpiece, a headband, a headphone, a headset, an earphone, a hand held device, a portable device, a desktop device, just to name a few.

In other examples, housing 199 may be configured as speaker, a subwoofer, a conference call speaker, an intercom, a media playback device, just to name a few. If configured as a speaker, then the housing 199 may be configured as a variety of speaker types including but not limited to a left channel speaker, a right channel speaker, a center channel speaker, a left rear channel speaker, a right rear channel speaker, a subwoofer, a left channel surround speaker, a right channel surround speaker, a left channel height speaker, a right channel height speaker, any speaker in a 3.1, 5.1, 7.1, 9.1 or other surround sound format including those having two or more subwoofers or having two or more center channels, for example. In other examples, housing 199 may be configured to include a display (e.g., DISP 180) for viewing video, serving as a touch screen interface, for a user, providing an interface for a GUI, for example.

PROX system 113 may include one or more sensors denoted as SEN 195 that are configured to sense 197 an environment 198 external to the housing 199 of media device 100. Using SEN 195 and/or other systems in media device 100 (e.g., antenna 124, SPK 160, MIC 170, etc.), PROX system 113 senses 197 an environment 198 that is external to the media device 100 (e.g., external to housing 199). PROX system 113 may be used to sense one or more of proximity of the user or other persons to the media device 100 or other media devices 100. PROX system 113 may use a variety of sensor technologies for SEN 195 including but not limited to ultrasound, infrared (IR), passive infrared (PIR), optical, acoustic, vibration, light, ambient light sensor (ALS), IR proximity sensors, LED emitters and detectors, RGB LED's, RF, temperature, capacitive, capacitive touch, inductive, just to name a few. PROX system 113 may be configured to sense location of users or other persons, user devices, and other media devices 100, without limitation. Output signals from PROX system 113 may be used to configure media device 100 or other media devices 100, to re-configure and/or re-purpose media device 100 or other media devices 100 (e.g., change a role the media device 100 plays for the user, based on a user profile or configuration data), just to name a few. A plurality of media devices 100 in an eco-system of media devices 100 may collectively use their respective PROX system 113 and/or other systems (e.g., RF 107, de-tunable antenna 124, AV 109, etc.) to accomplish tasks including but not limited to changing configuration, re-configuring one or more media devices, implement user specified configurations and/or profiles, insertion and/or removal of one or more media devices in an eco-system, just to name a few.

Simple Out-of-the-Box User Experience

Attention is now directed to FIG. 2A, where a scenario 200a depicts one example of a media device (e.g., media device 100 of FIG. 1 or a similarly provisioned media device) being configured for the first time by a user 201. For purposes of explanation, in FIG. 2A media device is denoted as 100a to illustrate that it is the first time the media device 100a is being configured. For example, the first configuration of media device 100a may be after it is purchased, acquired, borrowed, or otherwise by user 201, that is, the first time may be the initial out-of-the-box configuration of media device 100a when it is new. Scenario 200a depicts a desirable user experience for user 201 to achieve the objective of making the configuring of media device 100a as easy, straight forward, and fast as possible.

To that end, in FIG. 2A, scenario 200a may include media device 100a to be configured, for example, initially by user 201 using a variety of devices 202 including but not limited to a smartphone 210, a tablet 220, a laptop computer 230, a desktop PC or server 240, . . . etc. For purposes of simplifying explanation, the following description will focus on tablet 220, although the description may apply to any of the other devices 202 as well. Upon initial power up of media device 100a, controller 101 may command RF system 107 to electrically couple 224, transceiver BT 120 with antenna 124, and command BT 120 to begin listening 126 for a BT pairing signal from device 220. Here, user 201 as part of the initialization process may have already used a Bluetooth® menu on tablet 220 to activate the BT radio and associated software in tablet 220 to begin searching (e.g., via RF) for a BT device to pair with. Pairing may require a code (e.g., a PIN number or code) be entered by the user 201 for the device being paired with, and the user 201 may enter a specific code or a default code such as “0000”, for example.

Subsequently, after tablet 220 and media device 100a have successfully BT paired with one another, the process of configuring media device 100a to service the specific needs of user 201 may begin. In some examples, after successful BT pairing, BT 120 need not be used for wireless communication between media device 100a and the user's device (e.g., tablet 220 or other). Controller 101, after a successful BT pairing, may command RF system 107 to electrically couple 228, WiFi 130 with antenna 124 and wireless communications between tablet 220 and media device 100a (see 260, 226) may occur over a wireless network (e.g., WiFi or WiMAX) or other as denoted by wireless access point 270. Post-pairing, tablet 220 requires a non-transitory computer readable medium that includes data and/or executable code to form a configuration (CFG) 125 for media device 100a. For purposes of explanation, the non-transitory computer readable medium will be denoted as an application (APP) 225. APP 225 resides on or is otherwise accessible by tablet 220 or media device 100a. User 201 uses APP 225 (e.g., through a GUI, menu, drop down boxes, or the like) to make selections that comprise the data and/or executable code in the CFG 125.

APP 225 may be obtained by tablet 220 in a variety of ways. In one example, the media device 100a includes instructions (e.g., on its packaging or in a user manual) for a website on the Internet 250 where the APP 225 may be downloaded. Tablet 220 may use its WiFi or Cellular RE systems to communicate with wireless access point 270 (e.g., a cell tower or wireless router) to connect 271 with the website and download APP 255 which is stored on tablet 220 as APP 225. In another example, tablet 220 may scan or otherwise image a bar code or TAG operative to connect the tablet 220 with a location (e.g., on the Internet 250) where the APP 225 may be found and downloaded. Tablet 220 may have access to an applications store such as Google Play for Android devices, the Apple App Store for iOS devices, or the Windows 8 App Store for Windows 8 devices. The APP 225 may then be downloaded from the app store. In yet another example, after pairing, media device 1010 may be preconfigured to either provide (e.g., over the BT 120 or WiFi 130) an address or other location that is communicated to tablet 220 and the tablet 220 uses the information to locate and download the APP 225. In another example, media device 100a may be preloaded with one or more versions of APP 225 for use in different device operating systems (OS), such as one version for Android, another for iOS, and yet another for Windows 8, etc. In that OS versions and/or APP 225 are periodically updated, media device 100a may use its wireless systems (e.g., BT 120 or WiFi 130) to determine if the preloaded versions are out of date and need to be replaced with newer versions, which the media device 100a obtains, downloads, and subsequently makes available for download to tablet 220.

Regardless of how the APP 225 is obtained, once the APP 225 is installed on any of the devices 202, the user 201 may use the APP 225 to select various options, commands, settings, etc. for CFG 125 according to the user's preferences, needs, media device ecosystem, etc., for example. After the user 201 finalizes the configuration process, CFG 125 is downloaded (e.g., using BT 120 or WiFi 130) into DS system 103 in media device 100a. Controller 101 may use the CFG 125 and/or other executable code to control operation of media device 100a. In FIG. 2A, the source for APP 225 may be obtained from a variety of locations including but not limited to: the Internet 250; a file or the like stored in the Cloud; a web site; a server farm; a FTP site; a drop box; an app store; a manufactures web site; or the like, just to name a few. APP 225 may be installed using other processes including but not limited to dragging and dropping the appropriate file into a directory, folder, desktop or the like on tablet 220; emailing the APP 225 as an attachment, a compressed or ZIP file; cutting and pasting the App 225, just to name a few.

CFG 125 may include data such as the name and password for a wireless network (e.g., 270) so that WiFi 130 may connect with (see 226) and use the wireless network for future wireless communications, data for configuring subsequently purchased devices 100, data to access media for playback, just to name a few. By using the APP 225, user 201 may update CFG 125 as the needs of the user 201 change over time, that is, APP 225 may be used to re-configure an existing CFG 125. Furthermore, APP 225 may be configured to check for updates and to query the user 201 to accept the updates such that if an update is accepted an updated version of the APP 225 may be installed on tablet 220 or on any of the other devices 202. Although the previous discussion has focused on installing the APP 225 and CFG 125, one skilled in the art will appreciate that other data may be installed on devices 202 and/or media device 100a using the process described above. As one example, APP 225 or some other program may be used to perform software, firmware, or data updates on device 100a. DS system 103 on device 100a may include storage set aside for executable code (e.g., an operating system) and data used by controller 101 and/or the other systems depicted in FIG. 1.

Moving on to FIG. 2B, where a several example scenarios of how a previously configured media device 100a that includes CFG 125 may be used to configure another media device 100b that is initially un-configured. In scenario 200b, media device 100a is already powered up or is turned on (e.g., by user 201) or is otherwise activated such that its RF system 107 is operational. Accordingly, at stage 290a, media device 100a is powered up and configured to detect RF signatures from other powered up media devices using its RF system 107. At stage 290b another media device denoted as 100b is introduced into RF proximity of media device 100a and is powered up so that its RF system 107 is operational and configured to detect RF signatures from other powered up media devices (e.g., signature of media device 100a). Here RF proximity broadly means within adequate signal strength range of the BT transceivers 120, WiFi transceivers 130, or any other transceivers in RF system 107, RF systems in the users devices (e.g., 202, 220), and other wireless devices such as wireless routers, WiFi networks (e.g., 270), WiMAX networks, and cellular networks, for example. Adequate signal strength range is any range that allows for reliable RF communications between wireless devices. For BT enabled devices, adequate signal strength range may be determined by the BT specification, but is subject to change as the BT specification and technology evolve. For example, adequate signal strength range for BT 120 may be approximately 10 meters (e.g., ˜30 feet). For WiFi 130, adequate signal strength range may vary based on parameters such as distance from and signal strength of the wireless network, and structures that interfere with the WiFi signal. However, in most typical wireless systems adequate signal strength range is usually greater than 10 meters.

At stage 290b, media device 100b is powered up and at stage 290c its BT 120 and the BT 120 of media device 100a recognize each other. For example, each media device (100a, 100b) may be pre-configured (e.g., at the factory) to broadcast a unique RF signature or other wireless signature (e.g., acoustic) at power up and/or when it detects the unique signature of another device. The unique RF signature may include status information including but not limited to the configuration state of a media device. Each BT 120 may be configured to allow communications with and control by another media device based on the information in the unique RF signature. Accordingly, at the stage 290c, media device 100b transmits RF information that includes data that informs other listening BT 120's (e.g., BT 120 in 100a) that media device 100b is un-configured (e.g., has no CFG 125).

At stage 290d, media devices 100a and 100b negotiate the necessary protocols and/or handshakes that allow media device 100a to gain access to DS 103 of media device 100b. At stage 290e, media device 100b is ready to receive CFG 125 from media device 100a, and at stage 290f the CFG 125 from media device 100a is transmitted to media device 100b and is replicated (e.g., copied, written, etc.) in the DS 103 of media device 100b, such that media device 100b becomes a configured media device.

Data in CFG 125 may include information on wireless network 270, including but not limited to wireless network name, wireless password, MAC addresses of other media devices, media specific configuration such as speaker type (e.g., left, right, center channel), audio mute, microphone mute, etc. Some configuration data may be subservient to other data or dominant to other data. After the stage 290f, media device 100a, media device 100b, and user device 220 may wirelessly communicate 291 with one another over wireless network 270 using the WiFi systems of user device 220 and WiFi 130 of media devices 100a and 100b.

APP 225 may be used to input the above data into CFG 125, for example using a GUI included with the APP 225. User 201 enters data and makes menu selections (e.g., on a touch screen display) that will become part of the data for the CFG 125. APP 225 may also be used to update and/or re-configure an existing CFG 125 on a configured media device. Subsequent to the update and/or re-configuring, other configured or un-configured media devices in the user's ecosystem may be updated and/or re-configured by a previously updated and/or re-configured media device as described herein, thereby relieving the user 201 from having to perform the update and/or re-configure on several media devices. The APP 225 or a location provided by the APP 225 may be used to specify playlists, media sources, file locations, and the like. APP 225 may be installed on more than one user device 202 and changes to APP 225 on one user device may later by replicated on the APP 225 on other user devices by a synching or update process, for example. APP 225 may be stored on the internet or in the cloud and any changes to APP 225 may be implemented in versions of the APP 225 on various user devices 202 by merely activating the APP 225 on that device and the APP 225 initiates a query process to see if any updates to the APP are available, and if so, then the APP 225 updates itself to make the version on the user device current with the latest version.

Media devices 100a and 100b having their respective WiFi 130 enabled to communicate with wireless network 270, tablet 220, or other wireless devices of user 201. FIG. 2B includes an alternate scenario 200b that may be used to configure a newly added media device, that is, an un-configured media device (e.g., 100b). For example, at stage 290d, media device 100a, which is assumed to already have its WiFi 130 configured for communications with wireless network 270, transmits over its BT 120 the necessary information for media device 100b to join wireless network 270. After stage 290d, media device 100b, media device 100a, and tablet 220 are connected 291 to wireless network 270 and may communicate wirelessly with one another via network 270. Furthermore, at stage 290d, media device 100b is still in an un-configured state. Next, at stage 290e, APP 225 is active on tablet 220 and wirelessly accesses the status of media devices 100a and 100b. APP 225 determines that media device 100b is un-configured and APP 225 acts to configure 100b by harvesting CFG 125 (e.g., getting a copy of) from configured media device 100a by wirelessly 293a obtaining CFG 126 from media device 100a and wirelessly 293b transmitting the harvested CFG 125 to media device 100b. Media device 100b uses its copy of CFG 125 to configure itself thereby placing it in a configured state.

After all the devices 220, 100a, 100b, are enabled for wireless communications with one another, FIG. 2B depicts yet another example scenario where after stage 290d, the APP 225 or any one of the media devices 100a, 100b, may access 295 the CFG 125 for media device 100b from an external location, such as the Internet, the cloud, etc. as denoted by 250 where a copy of CFG 125 may be located and accessed for download into media device 100b. APP 265, media device 100b, or media device 100a, may access the copy of CFG 125 from 250 and wirelessly install it on media device 100b.

In the example scenarios depicted in FIG. 2B, it should be noted that after the pairing of media device 100a and tablet 220 in FIG. 2A, the configuration of media device 100b in FIG. 2B did not require tablet 220 to use its ST features to pair with media device 100b to effectuate the configuration of media device 100b. Moreover, there was no need for the BT pairing between tablet 220 and media device 100a to be broken in order to effectuate the configuration of media device 100b. Furthermore, there is no need for table 220 and media devices 100a and/or 100b to be BT paired at all with tablet 220 in order to configure media device 100b. Accordingly, from the standpoint of user 201, adding a new media device to his/her ecosystem of similarly provisioned media devices does not require un-pairing with one or more already configured devices and then pairing with the new device to be added to the ecosystem. Instead, one of the already configured devices (e.g., media device 100a having CFG 125 installed) may negotiate with the APP 225 and/or the new device to be added to handle the configuration of the new device (e.g., device 100b). Similarly provisioned media devices broadly means devices including some, all, or more of the systems depicted in FIG. 1 and designed (e.g., by the same manufacture or to the same specifications and/or standards) to operate with one another in a seamless manner as media devices are added to or removed from an ecosystem.

Reference is now made to FIG. 3 where a flow diagram 300 depicts one example of configuring a first media device using an application installed on a user device as was described above in regards to FIG. 2A. At a stage 302 a Bluetooth® (BT) discovery mode is activated on a user device such as the examples 202 of user devices depicted in FIG. 2A. Typically, a GUI on the user device includes a menu for activating BT discovery mode, after which, the user device waits to pick up a BT signal of a device seeking to pair with the user's device. At a stage 304 a first media device (e.g., 100a) is powered up (if not already powered up). At stage 306 a BT pairing mode is activated on the first media device. Examples of activating BT pairing mode include but are not limited to pushing a button or activating a switch on the first media device that places the first media device in BT pairing mode such that its BT 120 is activated to generate a RF signal that the user's device may discover while in discovery mode. I/O system 105 of media device 100 may receive 118 as a signal the activation of BT pairing mode by actuation of the switch or button and that signal is processed by controller 101 to command RF system 107 to activate BT 120 in pairing mode. In other examples, after powering up the first media device, a display (e.g., DISP 180) may include a touch screen interface and/or GUI that guides a user to activate the BT pairing mode on the first media device.

At a stage 308 the user's device and the first media device negotiate the BT pairing process, and if BT pairing is successful, then the flow continues at stage 310. If BT pairing is not successful, then the flow repeats at the stage 206 until successful BT pairing is achieved. At stage 310 the user device is connected to a wireless network (if not already connected) such as a WiFi, WiMAX, or cellular (e.g., 3G or 4G) network. At a stage 312, the wireless network may be used to install an application (e.g., APP 225) on the user's device. The location of the APP (e.g., on the Internet or in the Cloud) may be provided with the media device or after successful BT pairing, the media device may use its BT 120 to transmit data to the user's device and that data includes a location (e.g., a URI or URL) for downloading or otherwise accessing the APP. At a stage 314, the user uses the APP to select settings for a configuration (e.g., CFG 125) for the first media device. After the user completes the configuration, at a stage 316 the user's device installs the APP on the first media device. The installation may occur in a variety of ways (see FIG. 2A) including but not limited to: using the BT capabilities of each device (e.g., 220 and 100a) to install the CFG; using the WiFi capabilities of each device to install the CFG; and having the first media device (e.g., 100a) fetch the CFG from an external source such as the Internet or Cloud using its WiFi 130; just to name a few. Optionally, at stages 318-324 a determination of whether or not the first media device is connected with a wireless network may be made at a stage 318. If the first media device is already connected with a wireless network the “YES” branch may be taken and the flow may terminate at stage 320. On the other hand, if the first media device is not connected with a wireless network the “NO” branch may be taken and the flow continues at a stage 322 where data in the CFG is used to connect WiFi 130 with a wireless network and the flow may terminate at a stage 324. The CFG may contain the information necessary for a successful connection between WiFi 130 and the wireless network, such as wireless network name and wireless network password, etc.

Now reference is made to FIG. 4A, where a flow diagram 400a depicts one example of a process for configuring an un-configured media device “B” (e.g., un-configured media device 100b at stage 290b of FIG. 2B) using a configured media device “A” (e.g., media device 100a having CFG 125 of FIG. 2B). At a stage 402 an already configured media device “A” is powered up. At a stage 404 the RE system (e.g., RF system 107 of FIG. 1) of configured media device “A” is activated. The RF system is configured to detect RF signals from other “powered up” media devices. At a stage 406, an un-configured media device “B” (e.g., un-configured media device 100b at stage 290b of FIG. 2B) is powered up. At a stage 408 the RF system of un-configured media device “B” is activated. At stage 408, the respective RF systems of the configured “A” and un-configured “B” media devices are configured to recognize each other (e.g., via their respective BT 120 transceivers or another transceiver in the RE system). At a stage 410, if the configured “A” and un-configured “B” media devices recognize each other, then a “YES” branch is taken to a stage 412 where the configured media device “A” transmits its configuration (e.g., CFG 125) to the un-configured media device “B” (e.g., see stages 290e and 290f in FIG. 2B). If the configured “A” and un-configured “B” media devices do not recognize each other, then a “NO” branch is taken and the flow may return to an earlier stage (e.g., stage 404 to retry the recognition process. Optionally, after being configured, media device “B” may be connected with a wireless network (e.g., via WiFi 130). At a stage 414 a determination is made as to whether or not media device “B” is connected to a wireless network. If already connected, then a “YES” branch is taken and the process may terminate at a stage 416. However, if not connected with a wireless network, then a “NO” branch is taken and media device “B” is connected to the wireless network at a stage 418. For example, the CFG 125 that was copied to media device “B” may include information such as wireless network name and password and WiFi 130 is configured to effectuate the connection with the wireless network based on that information. Alternatively, media device “A” may transmit the necessary information to media device “B” (e.g., using BT 120) at any stage of flow 400a, such as at the stage 408, for example. After the wireless network connection is made, the flow may terminate at a stage 420.

Attention is now directed to FIG. 4B, where a flow diagram 400b depicts another example of a process for configuring an un-configured media device “B” (e.g., un-configured media device 100b at stage 290b of FIG. 28) using a configured media device “A” (e.g., media device 100a having CFG 125 of FIG. 2B). At a stage 422 an already configured media device “A” is powered up. At a stage 424 the RF system of configured media device “A” is activated (e.g., RF system 107 of FIG. 1). The RF system is configured to detect RF signals from other “powered up” media devices. At a stage 426, an un-configured media device “B” (e.g., un-configured media device 100b at stage 290b of FIG. 2B) is powered up. At a stage 428 the RF system of un-configured media device “b” is activated (e.g., RF system 107 of FIG. 1). At the stage 428, the respective RF systems of the configured “A” and un-configured “B” media devices are configured to recognize each other (e.g., via their respective BT 120 transceivers or another transceiver in the RE system). At a stage 430, if the configured “A” and un-configured “B” media devices recognize each other, then a “YES” branch is taken to a stage 432 where the configured media device “A” transmits information for a wireless network to the un-configured media device “B” (e.g., see stage 290b in FIG. 2B) and that information is used by the un-configured media device “B” to connect with a wireless network as was described above in regards to FIGS. 2B and 4A. If the configured “A” and un-configured “B” media devices do not recognize each other, then a “NO” branch is taken and the flow may return to an earlier stage (e.g., stage 424 to retry the recognition process. At a stage 434, the information for the wireless network is used by the un-configured media device “B” to effectuate a connection to the wireless network. At a stage 436, a user device is connected with the wireless network and an application (APP) running on the user device (e.g., APP 225 in FIG. 28) is activated. Stage 436 may be skipped if the user device is already connected to the wireless network. The APP is aware of un-configured media device “B” presence on the wireless network and at a stage 438 detects that media device “B” is presently in an un-configured state and therefore has a status of “un-configured.”Un-configured media device “B” may include registers, circuitry, data, program code, memory addresses, or the like that may be used to determine that the media device is un-configured. The un-configured status of media device “B” may be wirelessly broadcast using any of its wireless resources or other systems, such as RF 107 and/or AV 109. At a stage 440, the APP is aware of configured media device “A” presence on the wireless network and detects that media device “A” is presently in a configured state and therefore has a status of “configured.” The APP harvests the configuration (CFG) (e.g., CFG 125 of FIG. 2B) from configured media device “A”, and at a stage 442 copies (e.g., via a wireless transmission over the wireless network) the CFG to the un-configured media device “B.” At a stage 444, previously un-configured media device “B” becomes a configured media device “B” by virtue of having CFG resident in its system (e.g., CFG 125 in DS system 103 in FIG. 1). After media device “B” has been configured, the flow may terminate at a stage 446. In other examples, the APP may obtain the CFG from a location other than the configured media device “A”, such as the Internet or the Cloud as depicted in FIG. 2B. Therefore, at the stage 440, the APP may download the CFG from a web site, from Cloud storage, or other locations on the Internet or an intranet for example.

In the examples depicted in FIGS. 2A-4B, after one of the media devices is configured, additional media devices that are added by the user or are encountered by the user may be configured without the user (e.g., user 201) having to break a BT pairing with one media device and then establishing another BT pairing with a media device the user is adding to his/her media device ecosystem. Existing media devices that are configured (e.g., have CFG 125) may be used to configure a new media device using the wireless systems (e.g., acoustic, optical, RF) of the media devices in the ecosystem. If multiple configured media devices are present in the ecosystem when the user adds a new un-configured media device, configured media devices may be configured to arbitrate among themselves as to which of the configured devices will act to configured the newly added un-configured media device. For example, the existing media device that was configured last in time (e.g., by a date stamp on its CFG 125) may be the one selected to configure the newly added un-configured media device. Alternatively, the existing media device that was configured first in time (e.g., by a date stamp on its CFG 125) may be the one selected to configure the newly added un-configured media device. The APP 225 on the user device 220 or other, may be configured to make the configuration process as seamless as possible and may only prompt the user 201 that the APP 225 has detected an un-configured media device and query the user 201 as to whether or not the user 201 wants the APP 225 to configure the un-configured media device (e.g., media device 100b). If the user replies “YES”, then the APP 225 may handle the configuration process working wirelessly with the configured and un-configured media devices. If the user 201 replies “NO”, then the APP 225 may postpone the configuration for a later time when the user 201 is prepared to consummate the configuration of the un-configured media device. In other examples, the user 201 may want configuration of un-configured media devices to be automatic upon detection of the un-configured media device(s). Here the APP and/or configured media devices would automatically act to configure the un-configured media device(s).

APP 225 may be configured (e.g., by the user 201) to automatically configure any newly detected un-configured media devices that are added to the user's 201 ecosystem and the APP 225 may merely inform the user 201 that it is configuring the un-configured media devices and inform the user 201 when configuration is completed, for example. Moreover, in other examples, once a user 201 configures a media device using the APP 225, subsequently added un-configured media devices may be automatically configured by an existing configured media device by each media device recognizing other media devices (e.g., via wireless systems), determining the status (e.g., configured or un-configured) of each media device, and then using the wireless systems (e.g., RF 107, AV 109, I/O 105, OPT 185, PROX 113) of a configured media device to configure the un-configured media device without having to resort to the APP 225 on the user's device 220 to intervene in the configuration process. That is, the configured media devices and the un-configured media devices arbitrate and effectuate the configuring of un-configured media devices without the aid of APP 225 or user device 220. In this scenario, the controller 101 and/or CFG 125 may include instructions (e.g., fixed in a non-transitory computer readable medium) for configuring media devices in an ecosystem using one or more systems in the media devices themselves.

In at least some examples, the structures and/or functions of any of the above-described features may be implemented in software, hardware, firmware, circuitry, or in any combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, scripts, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” may refer, for example, to an algorithm or a portion thereof, and/or logic implemented in either hardware circuitry or software, or a combination thereof. These may be varied and are not limited to the examples or descriptions provided. Software, firmware, algorithms, executable computer readable code, program instructions for execution on a computer, or the like may be embodied in a non-transitory computer readable medium.

Characteristic-Based Communication

FIGS. 5A through 5D depict block diagrams of media devices that configure themselves based on characteristics that may be derived from a variety of inputs, data, content, configurations, or other information available to the media device(s). In FIG. 5A, an example scenario 500a depicts user 201 in space 560 having a telephonic conversation 555 with someone on user device 501 (e.g., a smart phone) which is in RF communications 539 with a source (e.g., cellular network, VoIP, Skype®, etc.) For purposes of explanation, user device 501 is depicted as a smart phone, but the user device 501 is not so limited and may be any device, such as those depicted as 202 in FIG. 2A, or other, for example. User 201 has a media device 100i that has already been configured (e.g., as described above) and is positioned in space 570 at an approximate distance 541d from user 201 and/or user device 501. User 201 and user device 501 move 543t, from space 560 to a space 570, through an opening 551 in a structure 550, for example. At distance 541d, media device 100i may either not be able to detect user 201 and/or user device 501 or may be configured to not respond or activate to a new role when the user 201 and/or user device 501 are beyond some distance or other metric that may be determined or sensed by media device 100i. Here, after user 201 has entered space 570 the distance between the user 201 and media device 100i has decreased to 541e. At distance 541e, various systems in media device 100i may be configured to access the environment in proximity of the media device 100i to determine if some action is to be taken by the media device 100i in response to one or more events in its surrounding environment.

Here, RF system 107 may sense 540 RF transmissions from the user device 501 SEN 195 in PROX 113 may detect 197 heat, motion, changes in air pressure, sound, vibration, or other, A/V 109 may detect sound 557 via MIC 170 or emit sound 553 (e.g., ultrasonic) via SPK 160 that is detected by MIC 170 and/or SEN 195, for example. In short, media device 100i detects the presence of user 201 and/or user device 501 and based on data in CFG 125a, may take some action.

In FIG. 58, one or more systems in media device 100i determine that user 201 is engaged in a phone conversation on device 501 and based on the user's 201 proximity (e.g., distance 541e), CFG 125a includes data that instructs media device 100i to transfer the audio and/or video content of the conversation from the user device 501 to the media device 100i. The user 201 desires the phone conversation to be switched from the user device 501 to a proximately located media device (e.g., 100i or other) when the user 201 and the media device 100i are in close enough proximity to each other to make using the media device 100i as a speaker phone, conference phone, etc. practicable. To that end, user 201 has included this preference in CFG 125a (e.g., via APP 225). In a scenario 500b, the user 201 continues the phone conversation with the user's voice being picked up 567 by MIC 170 and the voice of the person the user 201 is conversing with being heard 563 over SPK 160. APP 225 and/or CFG 125 may be embodied in a non-transitory computer readable medium and that medium may include executable code, instructions, data, and the like and may be configured for execution on one or more processors, CPU's, DSP's, base band processors or the like in media device 100 and/or a user device 501, for example.

Although not depicted in FIGS. 5A-5B, media device 100i may included a display DISP 180, and if the user is engaged in a video conference, Skype® video call, etc., then the video content may be switched from user device 501 to the media device 100i in scenario 500b. User 201 may also desire to have the media device 100i handle the data and bandwidth (e.g., content) associated with the phone or video call. To that end, instead of user device 501 communicating with a cell tower or other wireless source, media device 100i switches the data handling to one of its RF transceivers in RF 107 (e.g., WiFi 130) and communicates 544 with a source for the content 505. Although only one media device is depicted in FIGS. 5A and 5B there may be more devices as denoted by 521.

Turning attention now to FIG. 5C where scenario 500c depicts two media devices denoted as 100i and 100ii with each media device having been configured with configurations 125a and 125b respectively. Media device 100ii may be a headset mounted to the head, ear, or other portion of the user's 201 body. Media device 100ii may be in communications with a cell phone, smart phone, or some other user device (not shown). For purposes of explanation, it is assumed that media device 100ii is in communication with some device that at least provides audio content to user 201 through media device 100ii. As depicted, user 201 is initially positioned in space 560 and then moves 543t into space 570, for example through an opening 551 in structure 550. Media device 100i is positioned in space 570 and initially user 201 and media device 100i are at an approximate distance 541d from each other when user 201 is in space 560, and later at an approximated distance 541e when user 201 is in space 570. Configurations 125a, 125b, or both may be designed to cause media devices 100i and 100ii to change roles when user 201 is in proximity (e.g., within approximate distance 541e) of media device 100i and is listening to content, having a conversation, or other on media device 100ii as denoted by 555. Here, changing roles may mean media device 100ii and media device 100i wirelessly communicating with each other using their respective RF 107 and/or AA/109 systems (e.g., using BT 120, WiFi 130, AH 140, SPK 160, MIC 170, or other).

In FIG. 5D, with media devices 100i and 100ii at the approximate distance 541e of each other, user 201 may have designed configurations 125a, 125b, or both to require media device 100ii to hand off its content 555 to media device 100i such that any content (e.g., audio or conversation) occurring on media device 100ii is transferred over to media device 100ii. Therefore, the role of media device 100ii has changed from a speaker to a speaker phone or a conference phone, for example. Here, RF system 107 may sense 540 RF transmissions from media device 100ii (e.g., BT or WiFi), SEN 195 in PROX 113 may detect 197 heat, motion, changes in air pressure, sound, vibration, or other, A/V 109 may detect sound 557 via MIC 170 or emit sound 553 (e.g., ultrasonic) via SPK 160 that is detected by MIC 170 and/or SEN 195, for example. In short, media device 100i detects the presence of user 201 and/or media device 100ii and based on data in CFG 125a, may take some action. Media device 100ii may also detect its proximity to media device 100i using its systems, for example the systems depicted in media device 100 in FIG. 1. After transferring content 555 from media device 100ii to 100i, MIC 170 may pick up sound 567 from user 201 (e.g., the users voice) and SPK 160 may produce audio 563 of the speaker's conversation.

User 201 may have designed configurations 125a, 125b, or both to require media device 100i to hand back its handling of content 555 to media device 100ii when user 201 moves out of proximity (e.g., back to approximate distance 541d) of media device 100i. As one example, if user 201 leaves space 570 and returns to space 560 as denoted by dashed arrow 543f in FIGS. 5C and 5D, then media device 100i may transfer the content (e.g., audio, conversation) back to media device 100ii. Although only two media devices are depicted in FIGS. 5C and 5D there may be more devices as denoted by 521.

FIGS. 5C-5D depict one example of how configured media devices added to or introduced into an ecosystem of other media devices may be re-tasked to serve specific roles designated by the user 201, but without the user 201 having to take additional actions to effectuate the role changing. The user 201 need not use BT to break and make pairing connections in order to transfer content 555 from one media device to another media device. Here, the only intervention on part of the user 201 may have occurred when the user 201 previously configured at least one of the media devices using the APP 225, for example. The role each media device plays, and handoff of content between media devices is determined by many factors including but not limited to the content itself (e.g., music, video, conversation, images, etc.), relative distance between media devices (e.g., within RF, sensor, or acoustic proximity), MAC addresses 177 that are registered in DS 103 or elsewhere in each media device, how each media device is configured how one or more media devices are re-configured to serve a new or changing role, just to name a few. In FIGS. 5A 50, the goal is to provide a seamless handoff between media devices and/or user devices with minimal or no user 201 intervention. RF system 107 may detect BT transmissions (e.g., via BT 120), WiFi transmissions (e.g., via WiFi 130), Ad Hoc WiFi transmission (e.g., via AH 140), or other. Here one or more of the RF transceivers in RF 107 may be used for detection (e.g., sensing other RF sources or presence due to changes or disturbances in RF fields) and communications and the RF transceiver used by RE 107 is denoted as TXRX 510.

Moving on to FIG. 5A, a user 201 introduces 677 a media device 100ii into an ecosystem 600a in which another media device 100i already exists. For example, user 201 brings media device 100ii into sensor proximity 641d of media device 100i such that through any systems available to either device, they become aware of each other and their proximity to each other. Although, only two media devices are depicted, additional media devices may be present or may be introduced into ecosystem 600a as denoted by 621. Further, in subsequent FIGS., additional media devices will be introduced into ecosystem 600a to illustrate content based configuration and seamless handoff in an ecosystem having a plurality of media devices. User 201 may be streaming or listening to content 655 on user device 220, such as music from source 620 such as a library, playlist, network drive, the Internet, or the cloud, for example.

Continuing with FIG. 6A, user 201 has configured 125a media device 100i to serve many roles, such as for example, serving as a speaker phone or conference call phone, as a speaker to play back audio content, just to name a few. However, user 201 desires to have two channel playback of audio content when two media devices are present in ecosystem 600a. For example, ecosystem 600a may be an office, a study, bedroom, or other location in which the user 201 will listen to audio content using media device(s). Here, media device 100ii has already been configured 125b; however, if media device 100ii is not configured at the time it is recognized by media device 100i, then the configuration processes described above may be used to configure media device 100ii and the configuration of media device 100ii may occur without any intervention on part of user 201. For example, media device 100ii may be a recently purchased media device that has not been configured to the user's 201 specifications. APP 225 need not be used at all to accomplish configuration of media device 100ii. Media device 100i may operate to configure media device 100ii using the processes described above in reference to FIGS. 1-4B, or other portions of the present application.

Assuming for purpose of explanation that media device 100ii is already configured CFG 125b when introduced into ecosystem 600a, the configurations of either device (e.g., CFG 125a, CFG 125b, or both) may be used to arbitrate control and role assignment among the media devices. In FIG. 6A, an approximate distance 641d between the media devices is sufficient for each media device to recognize the other media device using RF 640 detected by their respective RF 107 systems, sensor 195 detection via by their respective PROX 113 systems, acoustic detection via their respective A/V 109 systems, for example. RE system 107 may detect BT transmissions (e.g., via BT 120), WiFi transmissions (e.g., via WiFi 130), Ad Hoc WiFi transmission (e.g., via AH 140), or other. Here one or more of the RF transceivers in RF 107 may be used for detection (e.g., sensing other RF sources or presence due to changes or disturbances in RF fields) and communications and is generally denoted as TXRX 610.

Given that media devices 100i and 100ii presently recognize each other and are configured, the CFG 125a of media device 100i is used to change the role of media device 100i from serving as a speaker (e.g., a mono speaker) to serving as a Left channel speaker L-ch due to introduction of media device 100ii into ecosystem 600a. Similarly, media device 100ii change its role from whatever role it served prior to being introduced into ecosystem 600a to serving as a Right channel speaker R-ch. Accordingly, a preference of the user 201 to listen in stereo (e.g., L-ch and R-ch) when two media devices (100i and 100ii) are within proximity of each other may be accomplished without user 201 intervention based on the configurations in one or more media devices (e.g., CFG 125a, CFG 125b, or both).

In one example, media device 100i may wirelessly communicate with media device 100ii to command, instruct, or otherwise effectuate the role change in media device 100ii. In another example, media device 100ii may wirelessly communicate with media device 100i and instruct media device 100i to change its role to L-ch and media device 100ii through its CFG 125b is enabled to effect a change from its present role to the R-ch role when it is in the presence of another media device serving in the L-ch role. In another example, one of the media devices operates as a master (e.g., 100ii) and the other media device (e.g., 100i) operates as a slave, and the master media device changes its role and the role of the slave media device.

In some examples, a media device in ecosystem 600a may obtain content 669 (e.g., audio, video, phone call, etc.) from a user device 220. In other examples, a media device in ecosystem 600a may obtain content 657 from a source 620 that the user device 220 was using prior to the role change described above. Here, the data payload, data bandwidth and other associated with user device 220 obtaining the content 655 is handed over to a media device in ecosystem 600a.

FIG. 68 depicts another ecosystem 600b where media devices 100i and 100ii are already present in the ecosystem 600b and serving roles as L-ch and R-ch speakers. Media device 100iii is introduced 677 into ecosystem 600b. All three media devices are aware of one another and in wireless communication 679 with one another. That is, each media device depicted senses the presence of the other media devices as was described above. Here, the various systems in each media device are not depicted to prevent unnecessarily complicating the description of FIG. 6B. Wireless communication between the media devices may be via wireless, optical, acoustic, or any combination of those wireless technologies. After being introduced 677 into the ecosystem 600b any one of the media devices may act (e.g., thorough its configuration CFG 125) to change a role of a media device in the ecosystem 600b based on may factors including but not limited to a type of content the user 201 or user device 220 is using and preferences of the user 201 when three media devices are present in ecosystem 600b. In the example depicted, user 201 prefers a three media device ecosystem to self-configure into a three speaker configuration comprised of left, right, and center channel speakers. In that media devices 100i and 100ii are already serving roles and right R-ch and left L-ch speakers respectively, media device 100iii is re-configured to serve as the center channel speaker denoted as C-ch. Content 655b, regardless of its source (e.g., user device 220, the internet, cloud, WiFi, etc.) may be serviced by any of the media devices as was described in FIG. 6A. Moreover, each media device may process the information in content 655b based on the type of data it includes. For example, if the content 655b includes stereo only data, then media devices 100i and 100ii may be configured to playback the R-ch and L-ch information respectively, while media device 100iii is muted because there is no C-ch information in the content 655b. In some examples, media device 100W may play the role of a phantom center channel when there is no C-ch information in the content 655b by, for example, processing or synthesizing the R-ch and L-ch information to form a phantom center channel. In other examples, information in content 655b includes R-ch, C-ch, and L-ch and all three media devices serve in their respective assigned roles for a three channel configuration.

Moving on to FIG. 6C, media device 100i that served in the R-ch role has been removed 681 from ecosystem 600b and is depicted in dashed outline to reflect that media device 100i is no longer present. Remaining media devices 100ii and 100iii are no longer in communications with media device 100i and are aware 679 of each other. Accordingly, they reconfigure into the user 201 preferred combination of R-ch and L-ch speakers with media device 100iii changing its role from a C-ch speaker to a R-ch speaker.

In FIG. 6D, the content 655b has changed, at east temporarily, because user 201 receives an incoming phone call 691. Media devices in ecosystem 600b are aware of user device 220 and user's 201 preference that when one or more of the media devices are available and a phone call is received, one of the available media devices harvests the content 655b and changes roles to a speaker phone or conference phone to handle the audio and/or video content of the phone call. Here, media device 100iii which initially served the role of C-ch speaker, detects the phone call 691, harvests the content 655b, and uses its MIC 170 and SPK 160 to communicate 693 the phone conversation with user 201. In that there are three media devices that could have switched roles based on content 655b, the CFG 125 of each device may be designed to arbitrate which of the three media devices switches roles and harvests the content 655b. For example: if a single media device is present, then that device switches roles; if two devices are present, then the last device to be introduced into the ecosystem switches roles; if R-ch and L-ch speakers are present, then the L-ch speaker switches roles; if R-ch, C-ch, and L-ch speakers are present, then the C-ch speaker switches roles; and so on. Any combination of role switching scenarios may be programmed or configured, and the foregoing are non-limiting examples.

Referring again to FIG. 6D, in another example, user 201 is wearing a headset that is also a media device 100iv. Media device 100iv is aware 679 of the other three media devices in ecosystem 600b. In the absence of the other three media devices, media device 100iv is configured to harvest the content 665b of phone call 691. However, because the other three media devices are in fact present, media device 100iv either doesn't take action on the phone call 691 and media device 100iii switches roles (e.g., as described above) to harvest the content 655b and process the call 691, or media device 100iv transfers the call to one of the other media devices that may serve as a speaker phone according to the design of CFG 125 in each media device.

In FIG. 6E, a more populated example of an ecosystem 600e initially includes a single media device denoted as 100i. Subsequently, additional media devices are introduced 677 (e.g., 677a-677i) into ecosystem 600e. All media devices are aware 679 of one another via wireless means using one or more of the systems depicted in FIG. 1 (e.g., RF, acoustic, optical, sensors, etc.). For example: media device 100ii is introduced 677a and devices 100i and 100ii change roles to become L-Ch and R-ch speakers; next media device 100iii is introduced 677b and it configures to a front center channel (FC-ch) speaker; next media devices 100iv and 100v are introduced 677c and 677d and they configure to rear left and right channel speakers LR-ch and RR-ch respectively; next media device 100vi is introduced 677e and it configures as a rear center channel (RC-ch) speaker; next media devices 100vii and 100viii are introduced 677f and 677g and they configure to left and right surround channels LS-ch and RS-ch respectively; next media device 100xi is introduced 677h and it configures to a first subwoofer channel SW1; and next media device 100xii is introduced 677i and it configures to a second subwoofer channel SW2. Media device 100xi and 100xii may be specially designed to serve as low frequency transducers (e.g., by their enclosure size and transduce design, such as woofer size, etc.) and may automatically configure to that role when introduced into an ecosystem, such as ecosystem 600e, for example. Media device 100xi and 100xii may be designed to include full range drivers such as tweeter and midrange drivers and also include a low frequency driver for use as a subwoofer. Media device 100xi and 100xii may also be designed to include other transducers such as SPK 160 and MIC 170, for example.

Ecosystem 600e may include more or fewer media devices than depicted in FIG. 6E as denoted by 621. In general, as media devices are introduced 677 or removed 681 from ecosystem 600e, remaining media devices may re-configured to serve different roles based on content 655b and their respective configurations CFG 125. Here, ecosystem 600e may be crafted by user 201 to implement a variety of surround sound formats or data such as a 2.1, 3.1, 5.1, 7.1, 9.1 format, for example. A plurality of media devices may be configured to implement a n.x surround sound format where n and x are both positive integers with n≧1 and x≧0. Ecosystem 600e may be positioned in a space in the user's home, such as a media room, family room, or great room, for example.

Attention is now directed to FIG. 7A where an ecosystem 700a includes four media devices 100i, 100ii, 100iii, and 100iv. User 201 and user device 220 are present in the ecosystem 700a. Media devices 100i, 100H, 100i and 100iv are aware of and in wireless communication with one another as denoted by 779. Wireless communication may include any combination of RF via RF system 107, acoustic via A/V system 109, or optical via OPT 185. Referring back to FIG. 1, each media device may include the PROX system 113 and its respective sensor devices SEN 195 in addition to A/V 109, RF 107, and OPT 185 systems. One or more of those systems may be configured to sense 711 the environment ENV 198 around a media device for a variety of purposes, such as detecting a presence of another person 201x (not shown) in personal proximity of user 201. Personal proximity may include within hearing range of speech from the user 201.

User 201 receives a phone call 791 and a decision as to where to route the content 755b for handling the phone call is made by media devices 100i, 100ii, 100iii, and 100iv based on their respective configurations (e.g., CFG 125) which in part are designed to comport with the user's 201 needs. Here, user 201 needs the conversation to be private, that is, not on speaker phone if other persons 201x are present within the sensor range of media devices 100i, 100ii, and 100iii, and wants to audio portion of content 755b routed to head unit 100iv to maintain privacy for the conversation. On the other hand, if no other persons 201x are detected (e.g., user 201 has relative privacy) in sensor range of media devices 100i, 100ii, and 100iii, then the user 201 wants at least the audio portion of content 755b to be routed to one of the media devices 100i, 100ii, and 100iii for use as a speaker phone and conversation 793 between the user 201 and the caller may take place over speaker phone. In some applications where the content 755b includes video or audio and video, the user 201 may have configured the media devices (e.g., via APP 225) to route the audio and video to a media device (e.g., to DISP 180) if the user 201 has relative privacy as detected by the media devices. On the other hand, if user 201 does not have relative privacy, then route the audio portion of the content 755b to headset 100iv and the video portion of the content to a display on user device 220.

In FIG. 7A, there are no persons 201x within sensor range of media devices 100i, 100ii, and 100iii. Accordingly, the user's 201 configuration preferences call for the content to be routed to media device 100ii, the L-ch speaker. In contrast, in FIG. 7B, at least one other person 201x is detected in the sensor range 711 of at least one of the media devices (e.g., 100i). Media devices 100i, 100ii, 100iii, and 100iv are aware that user 201 likely doesn't have relative privacy for the phone call and content 755b is routed to headset 100vi so that the conversation with the caller may proceed with privacy due to the presence of 201x (e.g., within earshot of user 201).

As another example of sensing the environment ENV 198 around a media device for a variety of purposes, in FIG. 7B, there may be another device 720 within sensing range 711 of media devices 100i, 100ii, 100iii, and 100iv. Here, RF system 107 may use one of its transceivers, the antenna 124 configured to be de-tuned 129 to detect the RF emissions 721 of device 720. Based on those sensory inputs, user 201 may configure the media devices 100i, 100ii, 100iii, and 100iv to regard the space around the user 201 as not be private and route content 755b to the headset 100iv to maintain privacy for the conversation.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A wireless media device, comprising:
a controller in electrical communication with
a data storage system having non-volatile memory that includes configuration data for configuring the wireless media device,
radio frequency (RF) system including at least one RF antenna configured to be selectively electrically de-tunable, the RF antenna electrically coupled with a plurality of RF transceivers that a communicate using different protocols, at least one of the plurality of RF transceivers comprises an Ad Hoc (AH) transceiver configured to wirelessly communicate only with other wireless media devices having the AH transceiver,
an audio/video (A/V) system including a loudspeaker electrically coupled with a power amplifier and a microphone electrically coupled with a preamplifier, and
a proximity sensing system including at least one sensor for sensing an environment external to the wireless media device.

2. The wireless media device of claim 1, wherein the RF system senses a RF signal including content from a user device the wireless media device is configured to recognize, and based on the content, the wireless media device uses a configuration to re-configure the wireless media device.

3. The wireless media device of claim 2, wherein the configuration comprises the configuration data in the data storage system of the wireless media device.

4. The wireless media device of claim 2, wherein the configuration comprises configuration data from a different wireless media device that is wirelessly communicated to the wireless media device using the RF system, the A/V system, or both.

5. The wireless media device of claim 1, wherein the configuration data includes data operative to cause the wireless media device to wirelessly re-configure a different wireless media device based on signals generated by a selected one or more of the RF system, the A/V system, or proximity sensing system.

6. The wireless media device of claim 1, wherein the configuration data includes data operative to cause the wireless media device to allow a different wireless media device to wirelessly re-configure the wireless media based on signals generated by a selected one or more of the RE, the A/V, or proximity sensing systems of the wireless media device, the different wireless media device, or both wireless media devices.

7. The wireless media device of claim 1, wherein the configuration data includes data operative to cause the wireless media device to wirelessly re-configure a different wireless media device based on signals generated by a selected one or more of the RF system, the A/V system, or proximity sensing system of the different wireless media device.

8. The wireless media device of claim 1, wherein the configuration data includes data operative to cause the wireless media device to re-configure itself to a surround sound speaker when a selected one or more of the RF system, the A/V system, or proximity sensing system of the wireless media device senses a different wireless media device.

9. The wireless media device of claim 8, wherein the surround sound speaker type is selected from the group consisting of a left channel speaker, a right channel speaker, a center channel speaker, a left-rear channel speaker, a right-rear channel speaker, a rear center channel speaker, a left surround speaker, a right surround speaker, a subwoofer, a left-front height speaker, a right-front height speaker, a left-rear height speaker, a right-rear height speaker, a front center channel speaker, and a rear center channel speaker.

10. The wireless media device of claim 1, wherein the configuration data includes data operative to cause the wireless media device to re-configure itself to speaker phone or conference call phone when a selected one or more of the RF system, the A/V system, or proximity sensing system of the wireless media device senses content comprising a phone conversation on a user device.

11. The wireless media device of claim 1, wherein the configuration data includes data operative to cause the wireless media device to re-configure itself from being a speaker phone or conference call phone when a selected one or more of the RF system, the A/V system, or proximity sensing system of the wireless media device senses content comprising a phone conversation on a user device and senses the presence of a person other than a user of the user device.

12. The wireless media device of claim 1, wherein the configuration data includes data operative to cause the wireless media device to re-configure itself from a first role to a second role based on different configuration data wirelessly transmitted from a different wireless media device.

13. A non-transitory computer readable medium for configuring a wireless media device, comprising:
first executable instructions operative to cause the wireless media device to configure itself for a first role;
second executable instructions operative to cause the wireless media device to configure itself for a second role that is different than the first role in response to information wirelessly transmitted from a different wireless media device.

14. The non-transitory computer readable medium of claim 13, wherein the first role comprises a first speaker type and the second role comprises a second speaker type that is different than the first speaker type.

15. The non-transitory computer readable medium of claim 13, wherein the first role comprises a speaker and the second role comprises a conference call speaker.

16. The non-transitory computer readable medium of claim 13, wherein the first executable instructions, the second executable instructions, or both reside in a configuration file stored in a non-volatile memory of the wireless media device.

17. A non-transitory computer readable medium for configuring a wireless media device, comprising:
first executable instructions operative to cause the wireless media device to configure itself for a first role;
second executable instructions operative to cause the wireless media device to configure itself for a second role that is different than the first role in response to content from a user device that is wirelessly sensed by the wireless media device.

18. The non-transitory computer readable medium of claim 17, wherein the content is selected from the group consisting of a phone conversation, audio, video, music, and surround sound data.

19. The non-transitory computer readable medium of claim 17, wherein the first executable instructions, the second executable instructions, or both reside in a configuration file stored in a non-volatile memory of the wireless media device.

20. The non-transitory computer readable medium of claim 17, wherein an application comprised of another non-transitory computer readable medium disposed on a wireless user device is operative to generate and wirelessly transmit the first executable instructions, the second executable instructions, or both from the wireless user device to the wireless media device.
